(19) United States
(12) Patent Application Publication
(10) Pub. No.: US 2013/0013871 A1
(43) Pub. Date: Jan. 10, 2013

(54) INFORMATION PROCESSING SYSTEM AND DATA PROCESSING METHOD

(75) Inventors: Kazutaka OGIHARA, Hachioji (JP); Yasuo Noguchi, Kawasaki (JP); Tatsuo Kumano, Kawasaki (JP); Masahisa Tamura, Kawasaki (JP); Yoshihiro Tsuchiya, Yokohama (JP); Toshihiro Ozawa, Yokohama (JP); Takashi Watanabe, Kawasaki (JP); Kazuichi Oe, Yokohama (JP)

(73) Assignee: FUJITSU LIMITED, Kawasaki-shi (JP)

(21) Appl. No.: 13/533,085

(22) Filed: Jun. 26, 2012

(30) Foreign Application Priority Data
Jul. 4, 2011 (JP) 2011-147907

(51) Int. Cl. G06F 12/00

(52) U.S. Cl. 711/156; 711/E12.001

(57) ABSTRACT

An information processing system includes a first processor to store data segments in a first memory, to send the data segments to be stored in the first memory to a second processor, and to read the data segments from the first memory so as to store the data segments in a second memory; and the second processor to store the data segments to be stored sent from the first processor in a third memory, wherein when the first processor notifies the second processor about data that is permitted to be removed, the first processor sends ID information to the second processor that renders a particular data segment that was last stored in the second memory identifiable, and the second processor removes from the third memory the particular data segment and an older data segment stored previous to the particular data segment from the data segments stored in the third memory.

### CROSS-REFERENCE TO RELATED APPLICATION(S)

This application is based upon and claims the benefit of priority of the prior Japanese Patent Application No. 2011-147907, filed on Jul. 4, 2011, the entire contents of which are incorporated herein by reference.

### FIELD

The embodiment discussed herein is related to an information processing system, an information processing program and a data processing method.

### BACKGROUND

An information processing system may copy data stored in a storage device possessed by a certain node into a storage device possessed by another node so as to duplicate the data. As an example of technology for duplicating data, a remote copy system that includes a primary storage system and a secondary storage system is disclosed. According to the technology, upon receiving a write request, the primary storage system attaches a write time to the write data and transfers the write data to the secondary storage system. Then, the secondary storage system stores the write data into a logical volume in the secondary storage system based on the write time.

Related art is disclosed, for example, in Japanese Laid-open Patent Publication No. 2006-221487.

### SUMMARY

According to an aspect of the invention, an apparatus includes a first processor configured to store a plurality of data segments in a first memory, the first processor being configured to send the data segments to be stored in the first memory to a second processor, the first processor being configured to read the data segments from the first memory so as to store the data segments in a second memory, the first processor being configured to send a notice about data that is permitted to be removed to the second processor; and the second processor configured to store the data segments to be stored sent from the first processor in a third memory, wherein when the first processor notifies the second processor about data that is permitted to be removed, the first processor sends ID information to the second processor that renders a particular data segment that was last stored in the second memory identifiable, and the second processor removes from the third memory the particular data segment rendered identifiable by the ID information and an older data segment stored previous to the particular data segment from the data segments stored in the third memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of functional blocks of an information processing system;

FIG. 2A illustrates an example of data structures of data stored in a first memory;

FIG. 2B illustrates an example of data included in a duplication request sent from a first processor to a second processor;

FIG. 3 illustrates an example of sequence for a duplication process;

FIGS. 4A to 4C illustrate a detailed example of data in the duplication process;

FIG. 5 is a flowchart that indicates an example of a process run on the first processor side (that is, when a write request has been received);

FIGS. 6A to 6C each illustrate an example of a portion of allocation processing for a first memory;

FIGS. 7A and 7B each illustrate an example of a portion of allocation processing for the first memory;

FIG. 8 is a flowchart that illustrates an example of a process run on the first processor side (that is, storing data in a storage unit);

FIG. 9 is a flowchart that illustrates an example of a process run on the second processor side (that is, when a write request is received); and

FIG. 10 illustrates an example of a hardware configuration.

### DESCRIPTION OF EMBODIMENT

The specification discloses an embodiment of a system in which a certain processor running a write-back process duplicates dirty data with a storage device of another processor, and a technology for reducing an information processing load to remove the duplicated data entirely from the system will be explained.

A write-back process is ordinarily run, for example, when a processor (hereinafter, first processor) of a certain computer receives a request to write data to a device, such as a hard disk, from a host computer, as follows. That is, first the first processor temporarily stores data in an internal storage device, such as a memory, (hereinafter, first memory) that the data may be promptly written into. Then, the first processor stores the data stored in the first memory in an external storage device, such as a hard disk (hereinafter, storage unit), and removes the corresponding data from the first memory. Data that has been stored in first memory and has not been stored in the storage unit is called dirty data. Upon having stored the data in the first memory and before storing the data in the storage unit, the first processor replies to the host computer with a response saying that the data has been completely written. The first processor may thereby reply to the host computer with a quick response.

However, after having been temporarily stored in the first memory and before being stored in the storage unit by the first processor, the data temporarily stored in the first memory may be lost for some reason. If the data is lost, although a response saying that the data has been completely written is sent to the host computer, in fact the data is lost without being stored in the storage unit. In order to avoid such a situation, the first processor sends a request to duplicate data to be stored in the first memory to another processor (named second processor hereafter) when storing the data in the first memory. Then, the second processor having received the dirty data stores the data in a second memory, which may be similar to the first memory. Thus the data in the first memory is duplicated in the second memory. If the data in the first memory, which is on the first processor side, is lost, the data stored in the second memory on the second processor side may be used, and the data may be stored in the storage unit.

In a system where dirty data is duplicated, when the first processor has stored the data in the storage unit and removed the corresponding data from the first memory, naturally the data stored in the second memory on the second processor side is rendered useless. Thus, when storing the data in the storage unit and removing the corresponding data from the first memory, the first processor requests the second processor to remove the corresponding data as well. Upon receiving the request for removal, the second processor removes (that is, purges) the corresponding data stored in the second memory. That is, each time the first processor stores data from the first memory in the storage unit, the first processor sends a request for removal to the second processor. Each time the second processor receives a request for removal, the second processor removes data from the second memory.

The technology of the embodiment explained in the specification is, as stated above, to reduce a preference to send a request for removal to the second processor each time data in the first memory is stored in the storage unit, to enable a plurality of data segments stored in the second memory to be removed together, and, in the context of the overall system, to reduce a data processing load used to remove the duplicated data.

Specifically, with the technology of the embodiment, the first processor sends ID information to the second processor which allows a data segment that was last stored in the storage unit to be identifiable. The “ID information which allows a data segment last stored in the storage unit to be identifiable”, if rephrased, means, out of the data stored in the first processor's first memory, information which allows a data segment that was stored earliest to be identified. That is, for the data stored in the first processor's first memory, if the data segment stored earliest is identifiable, an immediately preceding data segment is stored most recently in the storage unit.

Meanwhile, the second processor removes the data segment corresponding to data segment last stored in the storage unit, which may be identified via the ID information, and any data segment stored prior to the last stored data segment from the second memory.

To be more specific, according to the embodiment's disclosed technology, when the first processor stores data in the first memory, the first processor associates storage order information that indicates the order in which the data is stored in the first memory. When sending a duplication request for the data to the second processor, the first processor adds the corresponding storage order information to the data before sending the data. Furthermore, as ID information, the first processor also adds storage order information, which corresponds to the earliest stored data out of the data stored in the first memory, to the data before the data is sent. Then, the second processor stores received data in the second memory together with storage order information that corresponds to the received data. Meanwhile, based on the ID information received from the first processor, the second processor removes from the second memory both the data segment last stored in the storage unit and each data segment stored previously to the data segment last stored in the storage unit.

Because the first processor sends ID information to the second processor as above according to the embodiment's disclosed technology, the second processor may identify and remove data that is preferable to remove from the second memory. When the second processor is removing data, because, based on the ID information, the second processor may remove a data segment that was stored last in the storage unit and each data segment stored previous to that data segment from the second memory, the second processor may remove a plurality of data segments together. Furthermore, even if a single data segment may be removed (that is, only the data segment last stored in the storage unit may be removed), the first processor may prefer not to send a request for removal to the second processor each time the first processor stores data from the first memory in the storage unit. A data processing workload may thereby be reduced for the entire system.

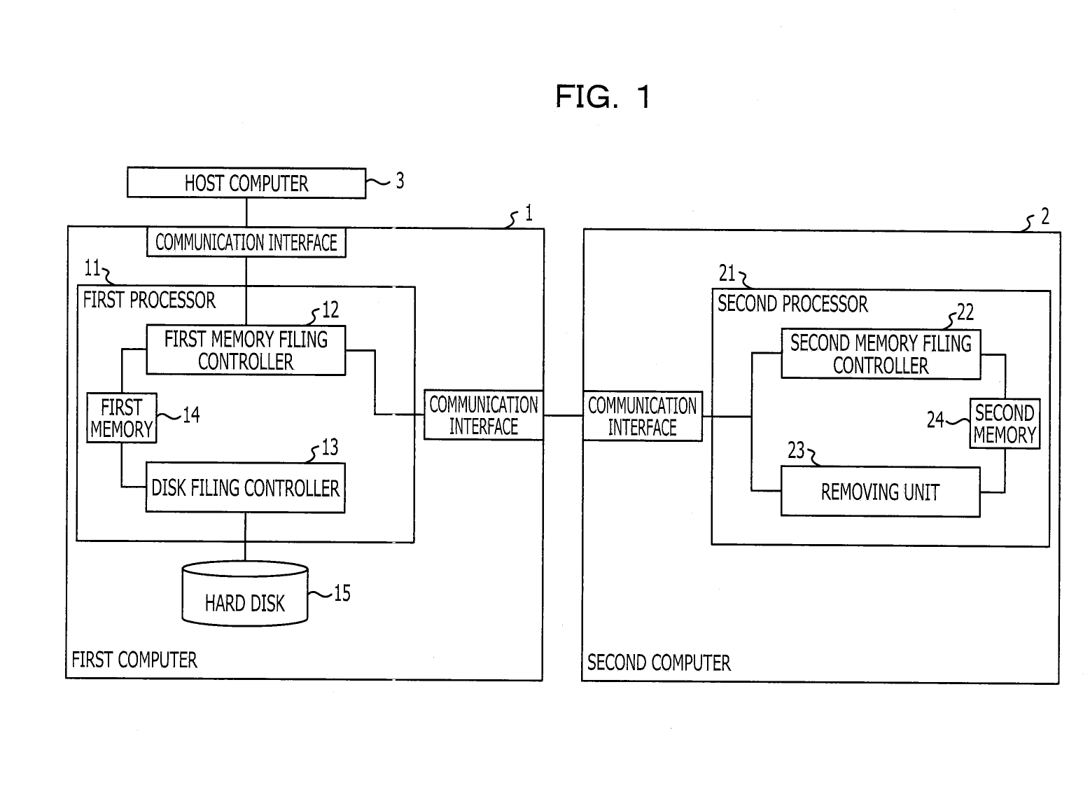

FIG. 1 is a block diagram of an example of a information processing system according to the embodiment.

The information processing system includes a first computer 1, a second computer 2 and a host computer 3. There are network connections that allow communication, such as, for example, by a local area network (LAN), between both the first computer 1 and the second computer 2, and the first computer 1 and the host computer 3. The first computer 1 and the second computer 2 include a first processor 11 and a second processor 21, respectively. Furthermore, the first computer 1 includes a storage unit 15, that is, an example of an external storage device.

The first processor 11 includes a first memory storing controller 12, a storage unit storing controller 13 and a first memory 14.

The first memory storing controller 12 associates a storage time, which is the current time, with data included in a write request that is received from the host computer 3, before temporarily storing the data in the first memory 14. At this time, the first memory storing controller 12 sends a duplication request for the data in the first memory 14 to the second processor 21.

Specifically, upon receiving a request to write data to the storage unit 15 from the host computer 3, the first memory storing controller 12 sets the storing time as the present time and sends to the second processor 21 of the second computer 2 a duplication request, which includes data included in the write request to which the storing time is added. The storing time is an example of order data that indicates an order in which data segments are stored. The first memory storing controller 12 adds to the request a storing time connected with an earliest-stored segment of data stored in the first memory 14 as an earliest time, and sends the duplication request to the second processor 21 of the second computer 2. The earliest time is an example of ID information which makes the data last stored in the storage unit 15 identifiable. In other words, the first memory storing controller 12 synchronizes the earliest time with the duplication request, and sends the earliest time to the second processor 21. Then, upon receiving a response from the second processor 21 indicating that the duplication has been completed, the first memory storing controller 12 stores the data, which is included in the write request received from the host computer 3, in the first memory 14. When storing the data, the first memory adds the above-mentioned storing time, which was associated with the data included in the write request, to the data before storing the data.

The storage unit storing controller 13, at regular intervals, reads, in the same chronological order as the storing time, data that was stored in the first memory 14 and stores the read data in the storage unit 15.

The second processor 21 includes a second memory storing controller 22, a removing unit 23 and a second memory 24.

Upon receiving a duplication request from the first processor 11, out of the data included in the received duplication request, the second memory storing controller 22 stores in the second memory 24 data that is included in the write request described above as well as the storing time that was added to the data.

Upon receiving a duplication request from the first processor 11, out of the data stored in the second memory 24, the removing unit 23 removes data that has a storing time older than the earliest time included in the duplication request.

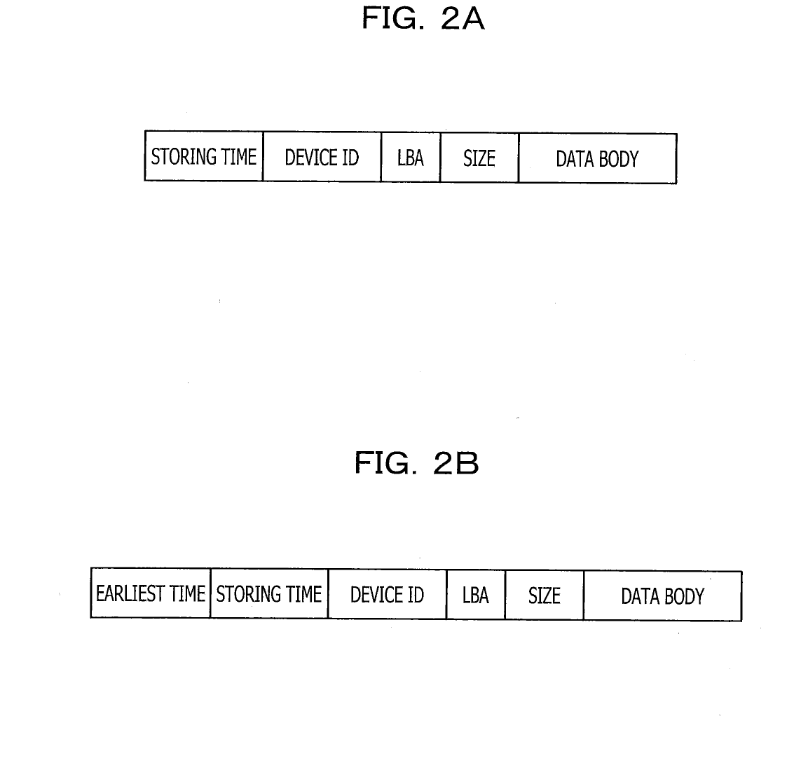

Next, the configuration of data stored in the first memory 14 and the second memory 24 as well as data that is included in a duplication request that the first processor 11 sends to the second processor 21 will be explained in detail with reference to FIGS. 2A and 2B.

FIG. 2A illustrates an example of a data configuration for data stored in the first memory 14. The data stored in the first memory 14 includes storing time, device ID, logical block address (LBA), size, and data body fields. The storing time indicates when the data is being stored in the first memory 14 as described above. The device ID, LBA, size, and data body fields are each data that is included in a write request received from the host computer 3. The device ID is an identifier that identifies a device that the data is stored in, and, according to the embodiment, is an identifier that indicates the storage unit 15. LBA is an address that indicates the storage location of the data in the storage unit 15. Size indicates the size of the data body. The data body is the specific body of data that is to be stored in the storage unit 15.

FIG. 2B illustrates a data configuration for data that is included in a duplication request that the first processor 11 sends to the second processor 21. The data in a duplication request include earliest time, storing time, device ID, LBA, size, and data body fields. As described above, out of the data stored in the first memory 14 when the data corresponding to the duplication request is sent to the second processor 21, the earliest time is the storing time for an earliest-stored segment of data that is stored in the first memory 14. The storing time, device ID, LBA, size, and data body fields are each same as the corresponding one of the data stored in the first memory 14 illustrated in FIG. 2A, and description thereof is omitted.

Furthermore, the configuration of data stored in the second memory 24 is the same as the configuration of data stored in the first memory 14, as illustrated in FIG. 2A. That is, the second memory storing controller 22 of the second processor 21 stores in the second memory 24 data that is in the fields in the configuration illustrated in FIG. 2B and is received from the first processor 11, except for the earliest time field.

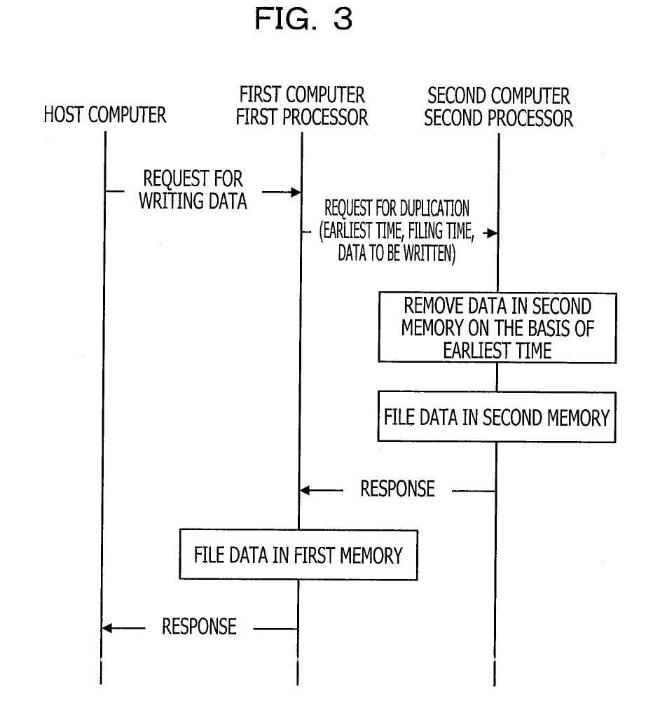

Next, an example of a processing flow for duplicating data, which the first processor 11 of the first computer 1 stores in the first memory 14, into the second memory 21 of the second processor will be explained with reference to the sequence chart in FIG. 3.

The host computer 3 sends a request to write data to the first processor 11 of the first computer 1. The request to write data includes a device ID, LBA, size, and the body of the data.

The first memory storing controller 12 of the first processor 11 sends a duplication request that includes the data included in the write request, to which storing time and earliest time are added, to the second processor of the second computer 2.

Upon receiving the duplication request, the removing unit 23 of the second processor 21 removes data stored in the second memory 24 whose storing time is before the received earliest time. Furthermore, upon receiving the duplication request, the second memory storing controller 22 stores, out of the data included in the duplication request, the device ID, LBA, size, body of the data, and storing time that was added to the data in the second memory 24. Then, the second memory storing controller 22 replies to the first processor 11 with a response saying that writing into the second memory 24 has completely finished.

Upon receiving the response from the second processor 21, the first memory storing controller 12 of the first processor 11 adds the storing time to the device ID, LBA, size and body of the data, and stores the device ID, LBA, size, and body of the data, to which the storing time has been added, in the first memory 14.

Furthermore, the first processor 11 of the first computer 1, which has received a response from the second computer 2, replies to the host computer 3 with a response indicating that the data that was requested to be written has been completely written.

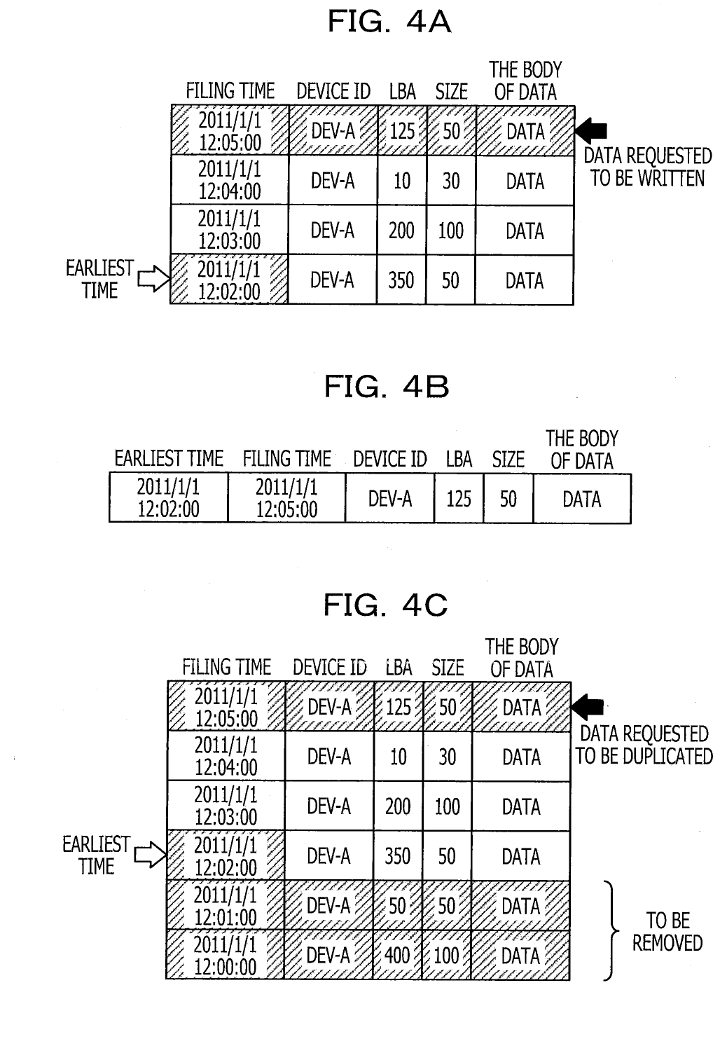

The duplication process described above will further be explained with reference to specific data examples from FIGS. 4A-4C.

First, FIG. 4A depicts the state of the first memory storing controller 12 of the first processor 11 having stored data in the first memory 14 after receiving a write request from the host computer 3. Data with a storing time of “2011/1/1 12:05:00” is stored after the write request is received. The earliest storing time for data stored in the first memory 14 is “2011/1/1 12:02:00”, which is the earliest storing time in this case.

FIG. 4B depicts a duplication request, which is sent to the second processor 21 by the first memory storing controller 12 of the first processor 11 after the write request is received from the host computer 3. That is, the duplication request is formed by including the data that has the storing time “2011/1/1 12:05:00”, as depicted in FIG. 4A, and adding the earliest storing time “2011/1/1 12:02:00”.

Furthermore, FIG. 4C depicts the state of the second processor 21 having received the duplication request and having stored the data included in the duplication request in the second memory 24. Referring to the data stored in the second memory 24 as shown in FIG. 4C, there are two data segments with a storing time before the earliest storing time “2011/1/1 12:02:00”. Thus, the removing unit 23 of the second processor 21 removes the two data segments and frees the corresponding memory area.

An explanation of the processing for the removing unit 23 is as follows. That is, as the duplication request includes the earliest storing time “2011/1/1 12:02:00”, the removing unit 23 may identify a segment of data included in the data stored in the second memory 24 that has a storing time of “2011/1/1 12:01:00”, which is before the earliest storing time and is also the most recent, as the data last stored in the storage unit 15. Thus, the removing unit 23 removes the data segment with the storing time “2011/1/1 12:01:00” identified in this way and any data segment with a storing time previous to the storing time “2011/1/1 12:01:00”, and frees the corresponding memory area.

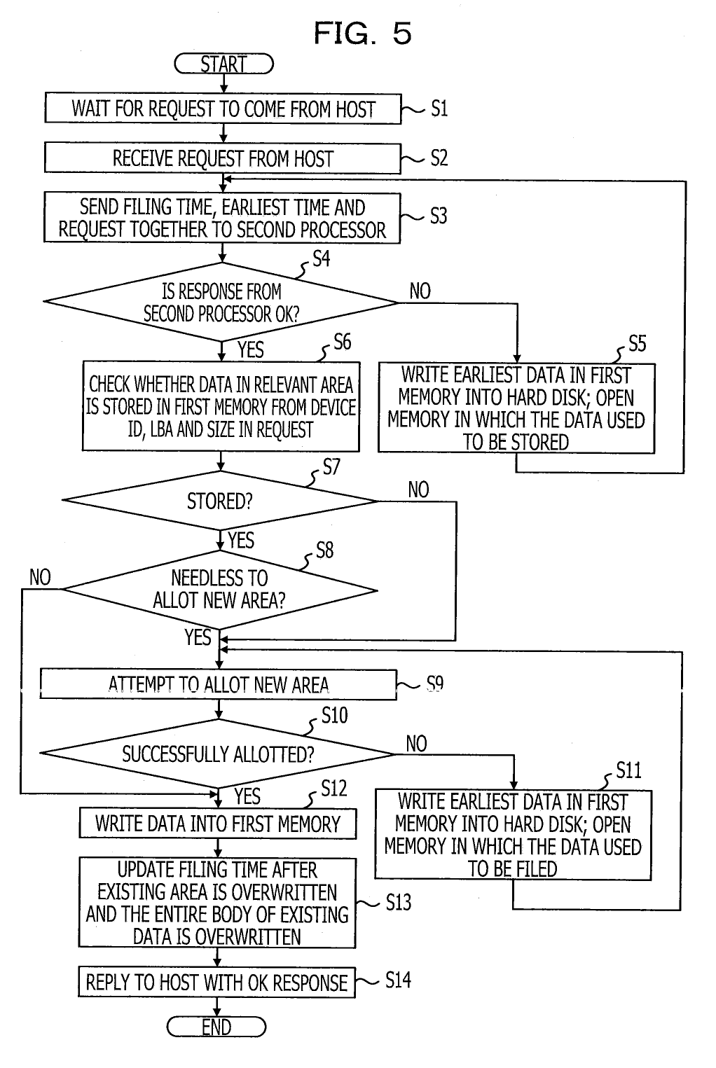

Next, processing run by each of the first processor 11 and the second processor 21 will be explained in detail with reference to FIGS. 5 to 9.

FIG. 5 is a flowchart that depicts processing run by the first processor 11 upon having received a request to write data from the host computer 3.

In S1, the first memory storing controller 12 waits for a request to write data to come from the host computer 3 at S1.

In S2, the first memory storing controller 12 receives a request to write data from the host computer 3.

In S3, the first memory storing controller 12 sends the second processor 21 a duplication request, which consists of the device ID, LBA, size, and data body as received from the host computer as well as the storing time and earliest time. Then, the first memory storing controller 12 waits for a response to come from the second processor 21.

In S4, the first memory storing controller 12 determines whether a response having come from the second processor 21 is an OK response indicating that the duplication has been successfully completed. If the response is an OK response (yes in S4), proceed to S6. If the response is a failure response indicating that the duplication has failed (no in S4), proceed to S5.

In S5, the storage unit storing controller 13 reads a segment of data with the earliest storing time among the data stored in the first memory 14, and stores the data segment so read in the storage unit 15. Then, the first memory storing controller 12 removes the data segment that has been stored in the storage unit 15 from the first memory 14. In other words, the first memory storing controller 12 frees an area in the first memory 14 in which the data segment used to be stored. Then, the flow returns to S3 to run the processing there.

In S6, the first memory storing controller 12 checks whether data of a storage area in which the body of the data to be written, which is included in the write request, is to be stored is stored in the first memory 14 based on the device ID, LBA, and size, which are included in the write request received from the host computer 3.

In S7, the first memory storing controller 12 determines whether data of a storage area, in which the body of the data to be written is to be stored, is stored in the first memory 14 as a result of the check at S6. If the data is stored (yes), the flow proceeds to S8. Unless the data is not stored (no), the flow proceeds to S9.

In S8, the first memory storing controller 12 determines whether it is not desirable to allocate a new memory area when the data that is included in the write request is stored in the first memory 14. If it is not preferable to allocate a new memory area (yes), the flow proceeds to S9. If it is preferable to allocate a new memory area (no), the flow proceeds to S11.

A reason why the processing in S6 to S8 is run is as follows. That is, if there is new data that is to be stored in the same storage area in the storage unit 15 as existing data that is stored both in the storage unit 15 and in the first memory 14, overwriting the body of the existing data in the first memory 14 with the body of new data to be stored means that it is not desirable to separately allocate a memory area in the first memory 14. Furthermore, integrating data by overwriting existing data with the body of new data means that the number of times that data is stored in the storage unit 15 may be reduced.

In S9, the first memory storing controller 12 attempts to allocate a memory area in the first memory 14 for the data included in the write request that is to be stored.

In S10, the first memory storing controller 12 determines whether a memory area in the first memory 14 has been successfully allocated for the data included in the write request that is to be stored. If the allocation succeeds (yes), the flow proceeds to S12. If the allocation fails (no), the flow proceeds to S11.

In S11, the storage unit storing controller 13 reads from the data stored in the first memory 14 a segment of data with an earliest storing time, and stores the data segment in the storage unit 15. Then, the first memory storing controller 12 frees the area in the first memory 14 in which the data segment used to be stored. Then, the flow returns to S9.

In S12, the first memory storing controller 12 stores the device ID, LBA, size, and body of the data, which are included in the write request, as well as the storing time, which was associated with the data in S3, in a suitable memory area in the first memory 14. Incidentally, to be stored in a suitable memory area means to be stored in a new memory area if a new memory area has been allocated. If it is not desirable to allocate a new memory area, storing in a suitable memory area means overwriting the body of existing data with the body of the data included in the write request.

In S13, if in S12 the first memory storing controller 12 has overwritten the memory area of existing data with the data included in the request, and if the first memory storing controller 12 has overwritten the body of the data in the first memory 14 entirely, the first memory storing controller 12 overwrites the storing time of the existing data with the storing time added at S3. Incidentally, the method for overwriting is only an example, and, for example, the storing time may be overwritten as well if only part of the body of the data is overwritten.

In S14, the first memory storing controller 12 replies to the host computer 3 with an OK response indicating that the data has been completely written.

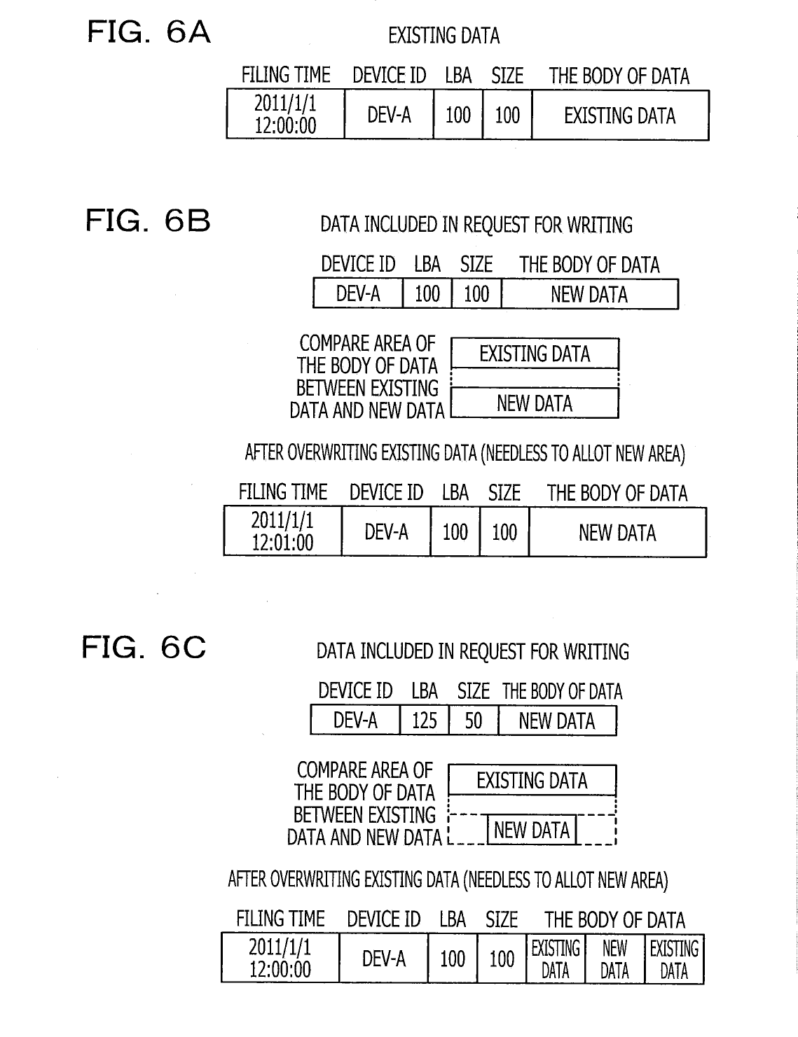

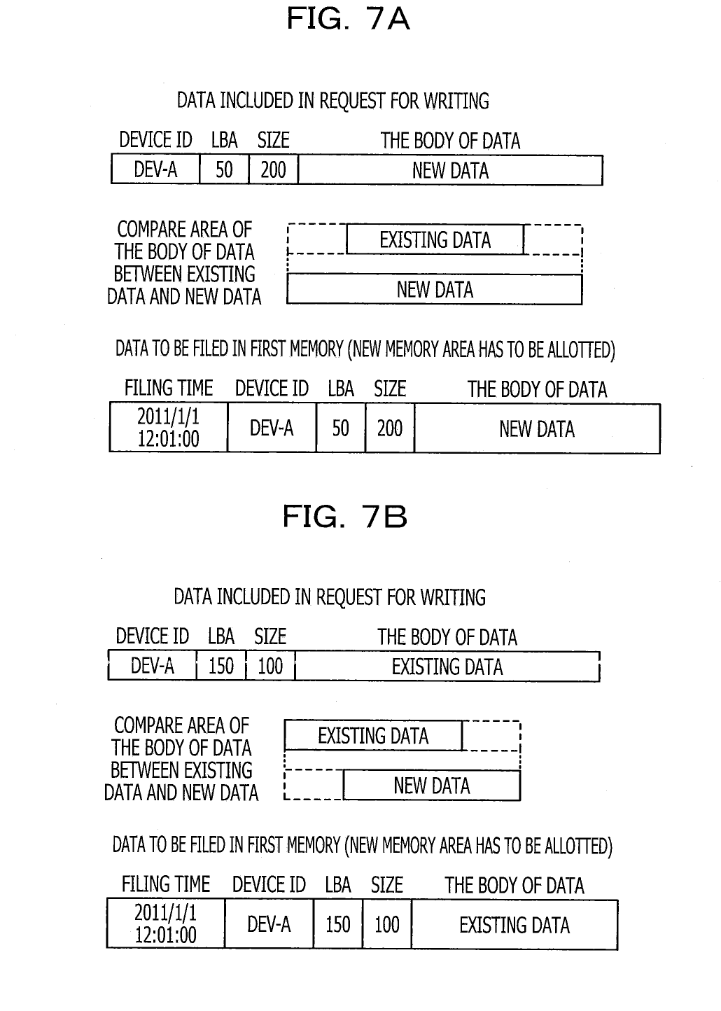

Incidentally, the process for allocating a memory area in the first memory 14 at S6 to S8 described above or at S34 to S36, which are discussed below, will be explained by the use of specific examples with reference to FIGS. 6A to 6C, 7A and 7B.

For example, suppose that data depicted in FIG. 6A is stored in the first memory 14. The data includes “DEV-A”, “100” and “100” in the device ID, LBA and size fields, respectively.

Then, suppose that data included in a new write request includes, for example, “DEV-A”, “100” and “100” in the device ID, LBA and size fields, respectively, as depicted in FIG. 6B. The body of the data from the write request is to be stored in the same storage area that the body of the existing data depicted in FIG. 6A is stored in. Thus, it is not desirable to allocate a new area in the first memory 14. The first memory storing controller 12 overwrites the body of the existing data with the body of the data from the write request. As a result, the data in the first memory 14 becomes the data depicted in FIG. 6B. In this case, as the first memory storing controller overwrote the entire body of the existing data, the first memory storing controller 12 overwrites the storing time with the new storing time (this corresponds to S13).

Next, suppose that data included in a new write request includes, for example, “DEV-A”, “125” and “50” in the device ID, LBA and size fields, respectively, as depicted in FIG. 6C. The body of the data is to be stored in a storage area that overlaps part of the storage area that the existing data depicted in FIG. 6A is stored in, as depicted in FIG. 6C. None of the data in the new write request is to be stored in a new area that is not allocated to the existing data. Thus, it is not desirable to allocate a new area in the first memory 14. The first memory storing controller 12 overwrites part of the body of the existing data with the body of the data from the new write request. As a result, the data stored in the first memory 14 becomes the data depicted in FIG. 6C. Incidentally, as the first memory storing controller 12 only overwrote part of the body of the existing data, the first memory storing controller 12 keeps the storing time for the existing data at this time (this corresponds to S13).

Next, suppose that data included in a new write request includes, for example, “DEV-A”, “50” and “200” in the device ID, LBA and size fields, respectively, as depicted in FIG. 7A. The body of the data from the write request is to be stored in a storage area which partially overlaps the storage area that the existing data depicted in FIG. 6A is stored in, and is also to be written into a storage area that is not allocated to the existing data. Thus, the first memory storing controller 12 allocates a new memory area in the first memory 14 and separately stores the data from the new write request.

Next, suppose that data in a new write request includes “DEV-A”, “150” and “100” in the device ID, LBA and size fields, respectively, as depicted in FIG. 7B. The body of the data from the write request is to be stored in a storage area which partially overlaps the storage area that the existing data depicted in FIG. 6A is stored in, and is also to be written into a storage area that is not allocated to the existing data. Thus, the first memory storing controller 12 allocates a new memory area in the first memory 14 and separately stores data from the new write request.

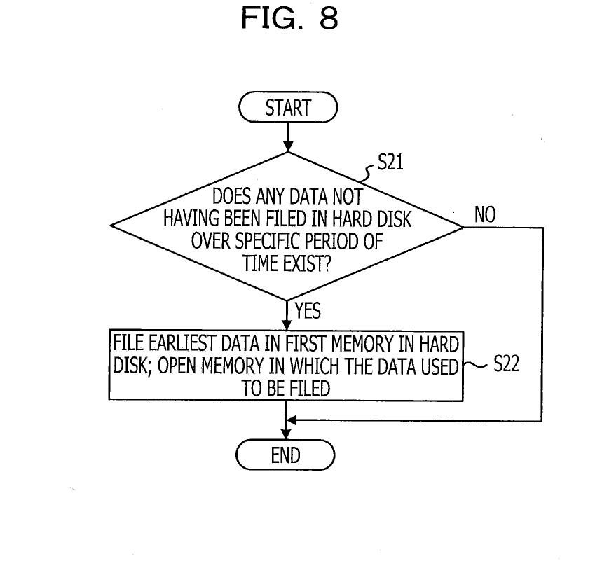

FIG. 8 is a flowchart that depicts a process for storing data in the storage unit 15 that is run by the first processor 11 at regular intervals. The regular interval is, for example, a specific period of time preset by a system administrator.

In S21, the storage unit storing controller 13 determines whether there is data in the first memory 14 that has not been stored in the storage unit 15 for an amount of time greater than or equal to the specific period of time. The storage unit storing controller 13 may make the determination by comparing the specific period of time subtracted from the present time with the storing time of data in the first memory 14. If there is data that has not been stored in the storage unit 15 for an amount of time greater than or equal to the specific period of time (yes), the flow proceeds to S22. If there is no such data, the process ends.

In S22, the storage unit storing controller 13 reads from the data stored in the first memory 14 a segment of data that has the earliest storing time, and stores the data segment so read in the storage unit 15. Then, the first memory storing controller 12 frees an area in the first memory 14 that the data segment was stored in.

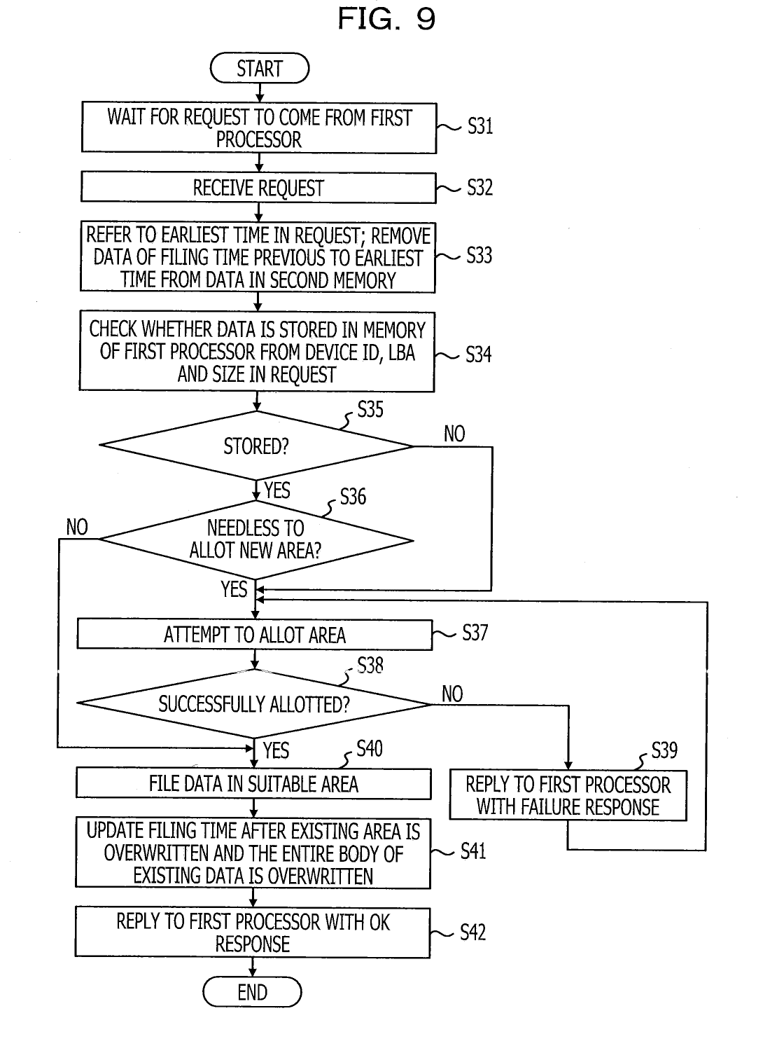

FIG. 9 is a flowchart that depicts a process run by the second processor 21 when a request to write data is received from the host computer 3.

In S31, the second memory storing controller 22 waits for reception of a duplication request from the first processor 11 of the first computer 1.

In S32, the second memory storing controller 22 receives a duplication request from the first processor 11.

In S33, the second memory storing controller 22 refers to the earliest time, which is included in the duplication request received from the first processor 11. Then, the second memory storing controller 22 removes data stored in the second memory 24 that has a storing time previous to the earliest time.

In S34, the second memory storing controller 22 checks whether data of a storage area in the storage unit 15 of the first processor, in which the body of the data to be duplicated that is included in the duplication request is to be stored, is stored in the second memory 24, based on the device ID, LBA and size included in the duplication request received from the first processor 11.

In S35, as a result of the check at S34, the second memory storing controller 22 determines whether data of a storage area in the storage unit 15 of the first processor 11, in which the body of the data to be duplicated that is included in the duplication request is to be stored, is stored in the second memory 24. If such data is stored (yes), the flow proceeds to S36. If no such data is stored (no), the flow proceeds to S37.

In S36, the second memory storing controller 22 determines whether it is not desirable to allocate a new memory area when the data requested to be written in the write request is stored in the second memory 24. If it is not desirable to allocate a new memory area (yes), the flow proceeds to S37. If it is desirable allocate a new memory area (no), the flow proceeds to S40.

Incidentally, a reason why the process run through S34 to S36 is similar to why the process is run through S6 to S8, which is described above. The process for allocating memory areas is similar to what was is explained above with reference to FIGS. 6A-6C, 7A and 7B, and description thereof is omitted.

In S37, the second memory storing controller 22 attempts to allocate in the second memory 24 a memory area to store the data included in the duplication request.

In S38, the second memory storing controller 22 determines whether a memory area, in the second memory 24, has been successfully allocated for the data included in the duplication request that is to be stored. If the allocation succeeds (yes), the flow proceeds to S40. If the allocation fails (no), the flow proceeds to S39.

In S39, the second memory storing controller 22 replies to the first processor 11 with a failure response that indicates that the duplication into the second memory 24 has failed.

In S40, the second memory storing controller 22 stores the device ID, LBA, size, and body of the data that are included in the duplication request in a suitable memory area in the second memory 24. Incidentally, to be stored in a suitable memory area means to be stored in a new memory area if a new memory area is allocated, similar to as described above for S12. If it is not desirable to allocate a new memory area, storing in a suitable memory area means overwriting the body of existing data with the body of the data included in the duplication request.

In S41, if in S40 the second memory storing controller 22 overwrote the memory area for existing data with the data included in the duplication request, and if the second memory controller 22 overwrote the all of the body of the data for the existing data stored in the second memory 24, the second memory storing controller 22 overwrites the storing time of the existing data with the storing time that is included in the duplication request.

In S42, the second memory storing controller 22 replies to the host computer 3 with an OK response indicating that duplication of the data has been successfully completed.

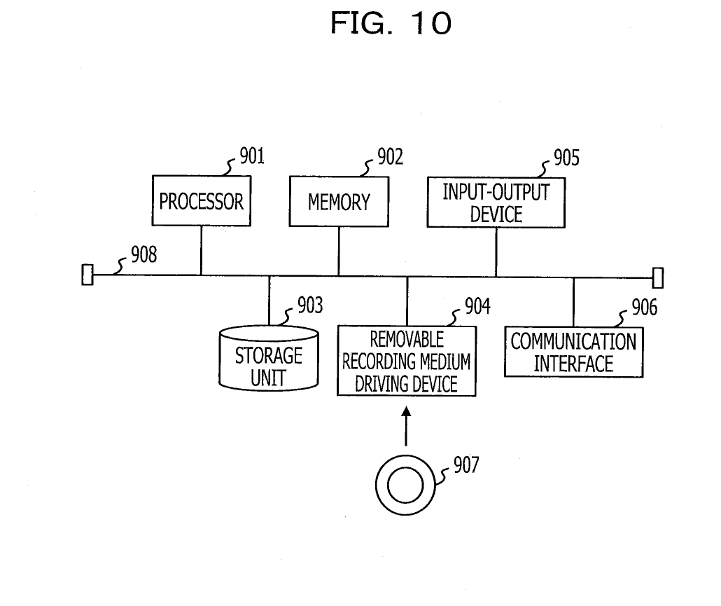

FIG. 10 depicts an example of a hardware configuration of a data processing device in which the first computer 1 and the second computer 2 described above are embodied. The data processing device includes a processor 901, a memory 902, a storage unit 903, a removable recording medium driving device 904, an input-output device 905 and a communication interface 906.

The processor 901 includes devices such as a running unit, a control unit, an arithmetic operation unit, and an instruction decoder. The running unit, following instructions from a program that is decoded by the instruction decoder, runs arithmetic and logical operations by using the arithmetic operation unit according to a control signal provided by the control unit. The processor 901 also includes a control register that various kinds of information are stored in for control purposes, a cache that may temporarily store the data that has already been accessed from devices such as the memory 2, and a translation lookaside buffer (TLB) that works as a cache for page tables for virtual storage. The configuration of the processor 901 may include a plurality of central processing unit (CPU) cores. The first processor 11 of the first computer 1 corresponds to the processor 901, as does the second processor 21 of the second computer 2.

The memory 902 is a storage device, such as random access memory (RAM). The memory 902 is a main memory in which a program to be run by the processor 901 is loaded and in which data to be used for processing run by the processor 901 is stored. The first memory 14 of the first computer 1 corresponds to the memory 902, as does the second memory 24 of the second computer 2.

The storage unit 903 is a storage device, such as a hard disk drive (HDD) or a flash memory. Programs and various kinds of data may be stored in the storage unit 903. The storage unit 15 of the first computer 1 corresponds to the storage unit 903.

The removable recording medium driving device 904 is a device that reads data or programs stored in a removable recording medium 907. The removable recording medium 907 is, for example, a medium such as a magnetic disk, an optical disk, a magneto-optical disk or a flash memory. While cooperating with the memory 902 and the storage unit 903, the processor 901 may run a program stored in the storage unit 903 or the removable recording medium 907. A program to be run by the processor 901 may be stored in another device communicably coupled with the data processing device, as may the data to be accessed.

The input-output device 905 is, for example, a device such as a keyboard, and a device such as a display monitor. The input-output device 905 accepts an instruction to work according to an action such as an operation from a user, and outputs a result of data processing performed by the data processing device.

The communication interface 906 is, for example, a device such as a LAN card. The communication interface 906 enables data communication with other communication devices. The respective components of the data processing device described above are coupled with one another via a bus 908.

According to the configuration and processing of the embodiment described above, the first processor 11 sends the earliest time, that is, the storing time of a data segment that is stored earliest in the first memory 14 to the second processor 21. The second processor 21 may thereby identify data stored in the second memory 24 that has a storing time previous to the earliest time as data that is to be removed, and may remove a plurality of data segments together. Even if only one data segment that has a storing time previous to the earliest time (that is, only data that is stored last in the storage unit 15) is in the second memory 24, according to the embodiment described above, the first processor 11 does not desire to send a request for data removal to the second processor 21 each time the first processor 11 stores data, which is stored in the first memory 14, in the storage unit 15. The amount of data for removal requests may be reduced. The system may thereby reduce the system's overall processing load.

Furthermore, the first processor 11 of the embodiment described above sends the earliest time added to a duplication request of data, which is to be stored in the first memory 14, to the second processor 21. It is thereby not desirable to send a request for removal only in order to remove data in the second memory 24, and the amount of data to be exchanged between the first and second processors may further be reduced.

Furthermore, the first or second processor 11 or 21 of the embodiment described above determines allocation of a memory area in steps S6 to S8 and S34 to S36. That is, when storing data that is included in a write request in the first memory 14, for example, regarding data to be stored in a storage area in which existing data is stored in, the first processor 11 overwrites the body of existing data with the body of the data that is to be stored in the same storage area. The first processor 11 may thereby avoid allocating new memory areas, and the number of times data is stored in the storage unit 15 may be reduced. The memory allocation process is similarly carried out in the second memory 24.

Furthermore, if the second processor 21 of the embodiment described above fails to allocate a memory area in the second memory 24, the first processor 11 stores data, which has been stored in the first memory 14, in the storage unit 15, updates the earliest time, and also sends a duplication request that includes the earliest time to the second memory 24 again so as to duplicate the data. The duplication of data to the second memory 24 may thereby be more certainly performed.

The first processor 11 does not have to limit the ID information to the earliest time, and may send any information that renders the data segment stored last in the storage unit 15 identifiable as the ID information. The first processor 11 may add, for example, data such as a sequence number, which indicates the order in which data is stored in the first memory 14, to data to be stored in the first memory 14 and also duplicated in the second memory. Then, the first processor 11 may send a sequence number for a segment of data stored in the first memory 14 that has the oldest sequence number, instead of the earliest time, to the second processor 21.

If no data segment is stored in the first memory 14, the first processor 11 may send, for example, an identifier that may be identified as indicating that there is no data instead of value such as the earliest time. Then, upon receiving the identifier, the second processor 21 may remove every data segment in the second memory 24.

The first processor 11 of the embodiment described above adds the earliest time to a request for duplicating data that is to be stored in the first memory 14 and sends the request to the second processor 21. The first processor 11 may send the earliest time to the second processor 21 at specific times independently of the duplication request. The second processor 21 may also remove a plurality of data segments together from the second memory 24. The second processor 21 may remove data from the second memory 24 more efficiently than if a request for removal is sent and data in the second memory 24 is removed each time data segments in the storage unit 15 are stored in the same chronological order that the data segments are stored in the first memory 14.

Furthermore, an object of the embodiment may be achieved even if decisions about allocating memory areas are made differently from S6-S8 or S34-S36 as described above and a memory area is newly allocated in the first memory 14 evenly for every data segment.

Although the first processor stores data in the first memory 14 after obtaining a response from the second processor 21, the first processor 11 may, for example, store data in the first memory 14 first and then send a duplication request to the second processor 21. Furthermore, the second processor 21 may run a process for removing data in the second memory 24 before running a process for storing data in the second memory 24, or at any time independent of the process for storing data in the second memory 24.

Furthermore, the embodiment is explained above only in a case where data is stored in the first memory 14 when the first processor 11 receives a request to write data from the host computer 3. However, for example, the embodiment may be applied when a program run by the first computer 1 itself makes a write request.

Although the first processor 11 and the second processor 21 are installed in separate computers according to the embodiment described above, the first processor 11 and the second processor 21 may be installed in the same computer. If so, data communication between the first processor 11 and the second processor 21 may be performed via a device such as a bus.

The embodiment described above is an example of system that runs a write-back process by using the first memory 14 and the storage unit 15. However, such a system may be implemented by a combination of devices as long as one of the devices is a storage device that performs high-speed storage processing and another device is a storage device that performs a relatively slower storage process. The technology may be applied, for example, to a duplication process in a system that runs a write-back process between a cache memory and a main memory. Furthermore, the first memory 14 and the second memory 24 may be installed outside the first processor 11 and the second processor 21, respectively, for configuration convenience.

Furthermore, for example, the storage unit 15 of the first computer 1 may be included in an external device different from the first computer 1. If that is the case, the first computer 1 is communicably coupled with the external device via a network, and first computer 1 accesses the storage unit 15 via the network.

The functional and physical configurations of the data processing device of the embodiment is not limited to what is described above. It is conceivable, for example, to integrate the respective functions and physical resources, or reversely, to divide them in order to implement the data processing device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A information processing system comprising:
a first processor configured to store a plurality of data segments in a first memory, the first processor being configured to send the data segments to be stored in the first memory to a second processor, the first processor being configured to read the data segments from the first memory so as to store the data segments in a second memory, the first processor being configured to send a notice about data that is permitted to be removed to the second processor; and
the second processor configured to store the data segments to be stored sent from the first processor in a third memory, wherein
when the first processor notifies the second processor about data that is permitted to be removed, the first processor sends ID information to the second processor that renders a particular data segment that was last stored in the second memory identifiable, and
the second processor removes from the third memory the particular data segment rendered identifiable by the ID information and an older data segment stored previous to the particular data segment from the data segments stored in the third memory.

2. The information processing system according to claim 1, wherein:
when the first processor stores the data segments, the first processor associates storage order information with each data segment before storing the data segment in the first memory, and
when the first processor sends the data segments to be stored, the first processor adds the storage order information that has been associated with the data segment to the data segment before sending the data segment;
the ID information is storage order information associated with the particular data segment; and
the second processor identifies the particular data segment based on the storage order information connected with the particular data segment, and identifies and removes the older data segment stored previous to the particular data segment.

3. The information processing system according to claim 1, wherein:
the first processor synchronizes transmission of the ID information with transmission of the data segments to be stored.

4. The information processing system according to claim 2, wherein:
the storage order information is related to storing time, which is when the first processor stores the data segments in the first memory.

5. The information processing system according to claim 4, wherein:
the data related to the storing time includes an earliest time associated with a data segment stored earliest in the first memory; and
the particular data segment has a storing time previous to the earliest time, and is the newest storing time with respect to the third memory.

6. The information processing system according to claim 1, wherein:
when the data segments to be stored are to be stored to an area of the second memory in which an other data segment is to be stored and the other data segment is already being stored in the first memory, the first processor overwrites the other data segment that is stored in the first memory with the data segments to be stored; and
when the data segments to be stored are to be stored to an area of the second memory in which an other data segment is to be stored and the other data segment is already being stored in the third memory, second processor overwrites the other data segment that is stored in the third memory with the data segments to be stored.

7. The information processing system according to claim 1, wherein:
when the second processor fails in allocating a memory area when storing the data segments to be stored in the second processor, the second processor replies to the first processor with a response indicating that the storage process failed; and
when the first processor receives the response from the second processor, the first processor reads the data segments that have been stored in the first memory from the first memory, stores the data segments in the second memory, and sends the ID information to the second processor again.

8. A non-transitory computer-readable recording medium storing an information processing program causing a computer to execute an operation, the operation comprising:
making the first processor store a plurality of data segments in a first memory, send the data segments to be stored in the first memory to a second processor, and read the data segments stored in the first memory from the first memory so as to store the data segments in a second memory; and
making the second processor store the data segments to be stored sent from the first processor in a third memory, wherein
when the first processor notifies the second processor about data that is permitted to be removed, the first processor sends ID information to the second processor that renders a particular data segment that was last stored in the second memory identifiable, and
the second processor removes from the third memory the particular data segment rendered identifiable by the ID information and an older data segment stored previous to the particular data segment from the data segments stored in the third memory.

9. A data processing method comprising:
storing a plurality of data segments in a first memory, sending the data segments to be stored in the first memory to a second processor, and reading the data segments stored in the first memory from the first memory so as to store the data segments in a second memory by means of a first processor; and
storing the data segments to be stored sent from the first processor in a third memory by means of the second processor, wherein
when the first processor notifies the second processor about data that is permitted to be removed, the first processor sends ID information to the second processor that renders a particular data segment that was last stored in the second memory identifiable, and
the second processor removes the particular data segment rendered identifiable by the ID information and an older data segment stored previous to the particular data segment from the data segments stored in the third memory.
